(19) United States
(12) Patent Application Publication
(10) Pub. No.: US 2022/0335179 A1
(43) Pub. Date: Oct. 20, 2022

(54) System and Method for Calibrating a Model of Thermal Dynamics

(71) Applicant: Mitsubishi Electric Research Laboratories, Inc., Cambridge, MA (US)

(72) Inventors: Ankush Chakrabarty, Bedford, MA (US); Christopher Laughman, Waltham, MA (US); Gordon Wichern, Boston, MA (US); Emilio Maddalena, Lausanne (CH)

(73) Assignee: Mitsubishi Electric Research Laboratories, Inc., Cambridge, MA (US)

(21) Appl. No.: 17/224,372

(22) Filed: Apr. 7, 2021

(51) Int. Cl. G06F 30/22; F24F 11/63; G06N 7/00; G05D 23/19

(52) U.S. Cl. CPC G06F 30/22; F24F 11/63; G06N 7/005; G05D 23/1917; G06F 2111/08

(57) ABSTRACT

A system and a method for calibrating a model of thermal dynamics of thermal state in an environment of a building conditioned by an operation of a heating, ventilating, and air-conditioning (HVAC) system is provided. The method includes receiving values of the control inputs to the actuators of the HVAC system and values of the thermal state at locations of the environment caused by the operation of the HVAC system according to the values of the control inputs, and computing a probabilistic surrogate model iteratively, using a Bayesian optimization, until a termination condition is met. The method further comprises outputting, when the termination condition is met, an optimal combination of the different parameters of the model of thermal dynamics having the largest likelihood of being a global minimum at the probabilistic surrogate model according to an acquisition function of the first two order moments of the calibration errors.

### TECHNICAL FIELD

The present disclosure relates generally to thermal dynamics and more particularly to a system and a method for calibrating a model of thermal dynamics.

### BACKGROUND

Simulation models of heating, ventilation, and cooling (HVAC) systems play a critical role in predicting system dynamics and enabling analysis, control, and optimization of buildings and equipment. Advantages of such physics-based modeling approaches are that their structure and parameter values are often available from construction documents, and information encoded in their mathematical structure tends to demonstrate accurate predictive properties in comparison to more generic model structures. The predictive capabilities often come at the cost of increased nonlinearity and numerical stiffness, which may make the simulation models difficult to solve and calibrate.

Calibration mechanisms are linked to a predictive performance of a physics-based model for a given building. Initial parameters obtained from tables of physical properties or architectural drawings may deviate from actual materials or geometry used in a built environment, while other model parameters (e.g. heat transfer coefficients) may only be derived from correlations or empirical observations. To that end, values of parameters of the simulation model that accurately represent observed data need to be identified by algorithms that optimize a given calibration-cost function.

However, the calibration-cost functions present numerical challenges because the calibration-cost functions are nonlinear and are seldom convex or differentiable with respect to calibrated parameters. Additionally, sensitivities of the calibration-cost functions vary locally. Population-based, gradient-free searches are scalable and effective, but incur high computational expenditure as they require an exorbitant number of simulations, which may not be suitable for stiff dynamical models that require long simulation times. Also, solely relying on dynamical estimators such as Kalman filters can also limit calibration performance due to multi-rate dynamics and poor generalizability of linearized models used to design the dynamical estimators.

In some approaches, a joint model considering both the HVAC system and a building envelope is calibrated. Although calibration of the HVAC system and the building envelope is performed independently, many variables contain information about both the building envelope and the HVAC system. Thus, the calibration of the joint model has the potential to yield more accurate parameters. However, the calibration of the joint model is challenging because of a large number of states and parameters.

### SUMMARY

It is an object of some embodiments to provide a system and a method for calibrating a model of thermal dynamics of thermal state in an environment of a building conditioned by an operation of a heating, ventilating, and air-conditioning (HVAC) system. The model of thermal dynamics is a digital twin model of dynamics of the operation of the HVAC system and thermal dynamics of the building. It is also an objective of some embodiments to provide a calibration technique that is tractable for high-dimensional parameter spaces. According to an embodiment, such an objective can be achieved by formulating a scalable Bayesian optimization framework employing sparse Gaussian processes.

The HVAC system includes actuators such as an indoor fan, an outdoor fan, an expansion valve actuator, and the like. The actuators may be controlled according to corresponding control inputs, e.g., a speed of the indoor fan, a speed of the outdoor fan, a position of the expansion valve, a speed of a compressor, and the like. Additionally or alternatively, in some implementations, the control inputs may include a value of temperature and/or a value of humidity. In response to controlling the actuators of the HVAC system according to the corresponding control inputs, the thermal state in the environment changes.

According to an embodiment, the control inputs are determined based on different parameters of the model of thermal dynamics. The model of thermal dynamics is a digital twin model of dynamics of an operation of the HVAC system and thermal dynamics of the building, such that the model of thermal dynamics explains the change of the thermal state in the environment. The different parameters of the model of thermal dynamics define a physical structure of one or combination of the building, the actuators of the HVAC system, and an arrangement of the HVAC system to condition the environment. For instance, the different parameters of the model of thermal dynamics include parameters of the building such as a thickness of a floor of the building, an infrared emissivity of a roof of the building, a solar emissivity of the roof of the building, an airflow infiltration rate, interior room air heat transfer coefficient (HTC), exterior air HTC, and the like. Additionally, in some embodiments, the different parameters of the model of thermal dynamics include HVAC parameters such as an outdoor HEX heat transfer coefficient (HTC) adjustment factor, an indoor HEX HTC adjustment factor, an indoor HEX Lewis number, an outdoor HEX vapor HTC, an indoor HEX vapor HTC, an outdoor HEX liquid HTC, an indoor HEX liquid, an outdoor HEX 2-phase HTC, an indoor HEX 2-phase HTC, and the like.

However, the different parameters of the model of thermal dynamics are difficult to measure or to estimate from other physical quantities, in practice. For example, refrigerant-side heat transfer coefficients (HTCs) depend on an amount of oil circulating in pipes of the HVAC system, configuration of tubes in a heat exchanger of the HVAC system, and other HVAC system and site-specific quantities, which are difficult to quantify. Additionally, uncertainties may exist in the dynamics of HVAC system operation, which makes the estimation of the different parameters of the model of thermal dynamics inaccurate. Also, the different parameters of the model of thermal dynamics are dynamic, i.e., the values of the different parameters vary over time. For example, a configuration of the building may be changed as a part of building maintenance or building repair work. The change in the configuration of the building affects the thermal dynamics of the building, which in turn leads to variation of the building parameters. Similarly, the HVAC parameters may change over time. Therefore, the different parameters of the model of thermal dynamics determined during a current time period may not be true at all times, or may be suboptimal for a different time period.

To mitigate such difficulties in estimation of the different parameters of the model of thermal dynamics, according to an embodiment, a calibration system for calibrating the model of thermal dynamics is provided. The calibration system may include a processor, and a memory configured to store instructions executable by the processor. The processor is configured to execute the instructions stored in the memory to perform steps required to calibrate the model of thermal dynamics. In an embodiment, the calibration system is configured to receive data indicative of measurements of the operation of the HVAC system conditioning the environment including values of the control inputs to the actuators of the HVAC system and values of the thermal state at locations of the environment caused by the operation of the HVAC system according to the values of the control inputs.

Further, the calibration system iteratively computes a probabilistic surrogate model using a Bayesian optimization, until a termination condition is met. The probabilistic surrogate model provides a mapping between various combinations of different values of the different parameters of the model of thermal dynamics and their corresponding calibration errors. The probabilistic surrogate model defines at least the first two order moments of the calibration errors. In an embodiment, the at least first two order moments may include a mean of the calibration error and a variance of the calibration error (also referred to as confidence range). For example, for a given a combination of different values of the different parameters of the model of thermal dynamics, the probabilistic surrogate model provides not only a calibration error but also a confidence range around the calibration error. Doing in such a manner can speed up the convergence of Bayesian optimization and reduce the computational burden of the calibration system.

For example, some embodiments aim to select a combination of the different parameters (also referred as ‘data point’) that has to be queried next. As used herein, querying the combination of the different parameters refers to simulation of the thermal state in the environment based on the model of thermal dynamics with the combination of the different parameters and the received values of the control inputs corresponding to the received values of the thermal state. Some embodiments use an acquisition function of the first two order moments of the calibration error to select the combination of the different parameters to query next.

The acquisition function uses the probabilistic mapping provided by the probabilistic surrogate model to select the combination of the different parameters to query next. In an embodiment, the acquisition function is maximized by the calibration system to select a combination of the different parameters having the largest likelihood of being a global minimum at the probabilistic surrogate model, for querying. Therefore, the acquisition function is used as a guidance to select the combination of different parameters to query next. To that end, the calibration system selects the combination of different parameters having the largest likelihood of being a global minimum at the probabilistic surrogate model according to the acquisition function of the first two order moments of the calibration errors.

Further, the calibration system estimates values of the thermal state at the locations in the environment by simulating the model of thermal dynamics with the selected combination of different parameters and the received values of the control inputs corresponding to the received values of the thermal state. The calibration system further estimates a calibration error for the selected combination of different parameters. In an embodiment, the calibration system estimates the calibration error based on a difference between the received values of the thermal state at the locations in the environment and the values of the thermal state at the locations in the environment estimated according to the model of thermal dynamics with the selected combination of different parameters and the received values of the control inputs corresponding to the received values of the thermal state.

Furthermore, the calibration system updates the probabilistic surrogate model based on the estimated calibration error for the selected combination of different parameters, using the Bayesian optimization. Further, in the next iteration, the calibration system selects a new combination of different parameters having the largest likelihood of being a global minimum at the updated probabilistic surrogate model, and estimates a calibration error for the new combination of different parameters. Subsequently, the calibration system again updates the updated probabilistic surrogate model based on the estimated calibration error for the new combination of different parameters, using the Bayesian optimization. Likewise, the probabilistic surrogate model is iteratively computed/updated until a termination condition is met. In an embodiment, the termination condition includes a number of iterations defined by a user.

The calibration system monitors if the termination condition is met. When the termination condition is met, the calibration system outputs an optimal combination of different parameters of the model of thermal dynamics having the largest likelihood of being a global minimum at the probabilistic surrogate model.

The optimal combination of different parameters of the model of thermal dynamics may be determined, as described above, offline (i.e., in advance). Additionally or alternatively, in some implementations, the optimal combination of different parameters of the model of thermal dynamics may be determined online, i.e., in real-time. For instance, the calibration system may be integrated with the HVAC system installed to condition the environment, and the calibration system may output the optimal combination of different parameters during the operation of the HVAC system. Further, in some alternate embodiments, the optimal combination of different parameters of the model of thermal dynamics may be determined offline, and the model of thermal dynamics may be updated online. For instance, the optimal combination of different parameters of the model of thermal dynamics is determined offline and submitted to a controller of the HVAC system. The controller may determine control inputs to the actuator of the HVAC system based on the optimal combination of different parameters. However, when the physical structure of the building and/or the actuators of the HVAC system changes, the calibration system may update the model of thermal dynamics online by estimating a new optimal combination of different parameters in real time according to the change in the physical structure of the building and/or the actuators of the HVAC system. Further, the new optimal combination of different parameters may be submitted to the controller of the HVAC system. Consequently, the controller may determine control inputs to the actuator of the HVAC system based on the new optimal combination of different parameters.

In an embodiment, the Bayesian optimization includes the probabilistic surrogate model using a Gaussian process for providing the probabilistic mapping, and the acquisition function that exploits the probabilistic mapping provided by the probabilistic surrogate model to direct the querying of a consequent combination of the different parameters of the model of thermal dynamics.

Some embodiments are based on the recognition that inversion and determinant operations typically used in the Gaussian process (GP) result in cubic complexity with the number of data points, which implies that using the Gaussian process in moderate or high-dimensional parameter spaces is not practical, since finding optimal solutions in such spaces typically requires sampling and evaluating the calibration-cost function a large number of times. To render the Bayesian optimization (BO) tractable in high-dimensional parameter spaces, some embodiments provide a scalable BO framework employing sparse Gaussian processes. To that end, an SGP-based Bayesian Optimization (SGP-BO) is formulated.

Accordingly, one embodiment discloses a calibration system for calibrating a model of thermal dynamics of thermal state in an environment of a building conditioned by an operation of a heating, ventilating, and air-conditioning (HVAC) system. The model of thermal dynamics is a digital twin model of dynamics of the operation of the HVAC system and thermal dynamics of the building, such that the model of thermal dynamics explains a change of the thermal state in the environment in response to controlling actuators of the HVAC system according to corresponding control inputs based on different parameters of the model of thermal dynamics defining a physical structure of one or combination of the building, the actuators of the HVAC system, and an arrangement of the HVAC system to condition the environment. The calibration system comprises: at least one processor; and memory having instructions stored thereon that, when executed by the at least one processor, cause the calibration system to: receive data indicative of measurements of the operation of the HVAC system conditioning the environment including values of the control inputs to the actuators of the HVAC system and values of the thermal state at locations of the environment caused by the operation of the HVAC system according to the values of the control inputs; compute a probabilistic surrogate model providing a probabilistic mapping between various combinations of different values of the different parameters of model of thermal dynamics and their corresponding calibration errors, wherein the probabilistic surrogate model defines at least the first two order moments of the calibration errors, and wherein the probabilistic surrogate model is computed iteratively using a Bayesian optimization until a termination condition is met; and output, when the termination condition is met, an optimal combination of the different parameters of the model of thermal dynamics having the largest likelihood of being a global minimum at the probabilistic surrogate model according to an acquisition function of the first two order moments of the calibration errors.

Accordingly, another embodiment discloses a calibration method for calibrating a model of thermal dynamics of thermal state in an environment of a building conditioned by an operation of a heating, ventilating, and air-conditioning (HVAC) system. The model of thermal dynamics is a digital twin model of dynamics of the operation of the HVAC system and thermal dynamics of the building, such that the model of thermal dynamics explains a change of the thermal state in the environment in response to controlling actuators of the HVAC system according to corresponding control inputs based on different parameters of the model of thermal dynamics defining a physical structure of one or combination of the building, the actuators of the HVAC system, and an arrangement of the HVAC system to condition the environment. The calibration method comprises: receiving data indicative of measurements of the operation of the HVAC system conditioning the environment including values of the control inputs to the actuators of the HVAC system and values of the thermal state at locations of the environment caused by the operation of the HVAC system according to the values of the control inputs; computing a probabilistic surrogate model providing a probabilistic mapping between various combinations of different values of the different parameters of model of thermal dynamics and their corresponding calibration errors, wherein the probabilistic surrogate model defines at least the first two order moments of the calibration errors, and wherein the probabilistic surrogate model is computed iteratively using a Bayesian optimization until a termination condition is met; and outputting, when the termination condition is met, an optimal combination of the different parameters of the model of thermal dynamics having the largest likelihood of being a global minimum at the probabilistic surrogate model according to an acquisition function of the first two order moments of the calibration errors.

Accordingly, yet another embodiment discloses a non-transitory computer readable storage medium embodied thereon a program executable by a processor for performing a method for calibrating a model of thermal dynamics of thermal state in an environment of a building conditioned by an operation of a heating, ventilating, and air-conditioning (HVAC) system, wherein the model of thermal dynamics is a digital twin model of dynamics of the operation of the HVAC system and thermal dynamics of the building, such that the model of thermal dynamics explains a change of the thermal state in the environment in response to controlling actuators of the HVAC system according to corresponding control inputs based on different parameters of the model of thermal dynamics defining a physical structure of one or combination of the building, the actuators of the HVAC system, and an arrangement of the HVAC system to condition the environment. The method comprises: receiving data indicative of measurements of the operation of the HVAC system conditioning the environment including values of the control inputs to the actuators of the HVAC system and values of the thermal state at locations of the environment caused by the operation of the HVAC system according to the values of the control inputs; computing a probabilistic surrogate model providing a probabilistic mapping between various combinations of different values of the different parameters of model of thermal dynamics and their corresponding calibration errors, wherein the probabilistic surrogate model defines at least the first two order moments of the calibration errors, and wherein the probabilistic surrogate model is computed iteratively using a Bayesian optimization until a termination condition is met; and outputting, when the termination condition is met, an optimal combination of the different parameters of the model of thermal dynamics having the largest likelihood of being a global minimum at the probabilistic surrogate model according to an acquisition function of the first two order moments of the calibration errors.

### BRIEF DESCRIPTION OF THE DRAWINGS

FIG. 1A shows a block diagram of principles used by some embodiments for calibrating a model of thermal dynamics of thermal state in an environment of a building.

FIG. 1B illustrates a mean and a confidence range provided by a probabilistic surrogate model, according to some embodiments.

FIG. 1C shows a block diagram of iterative computation of the probabilistic surrogate model using a Bayesian optimization, according to an embodiment.

FIG. 1D shows a curve of an acquisition function for selecting a combination of different parameters that has to be queried next, according to some embodiments.

FIG. 2 shows a block diagram of a calibration system for calibrating the model of thermal dynamics, according to some embodiments.

FIG. 3 shows a block diagram of a Gaussian process (GP) for determining the probabilistic surrogate model, according to some embodiments.

FIG. 4 shows a block diagram for selecting a data point to query next, according to some embodiments.

FIG. 5A shows some components of thermal dynamics of the building and HVAC system that are modeled in the model of thermal dynamics, according to some embodiments.

FIG. 5B shows a comparison table of the best estimates and true values of parameters of the model of thermal dynamics, according to some embodiments.

FIG. 5C shows plots that illustrate how well a calibrated model has fit measured HVAC outputs, according to some embodiments.

FIG. 5D shows plots that illustrate how well the calibrated model has fit measured building thermal outputs, according to some embodiments.

FIG. 6 shows a plot of training time v/s a number of datapoints for an exact GP and a sparse GP, according to some embodiments.

FIG. 7 shows box plots depicting performance of calibrating the model of thermal dynamics and robustness of calibrating using a sparse GP-based Bayesian optimization, according to some embodiments.

FIG. 8 shows a working environment of the calibration system providing a cloud service to the HVAC system, according to some embodiments.

FIG. 9 shows a flowchart of a calibration method for calibrating the model of thermal dynamics, according to some embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

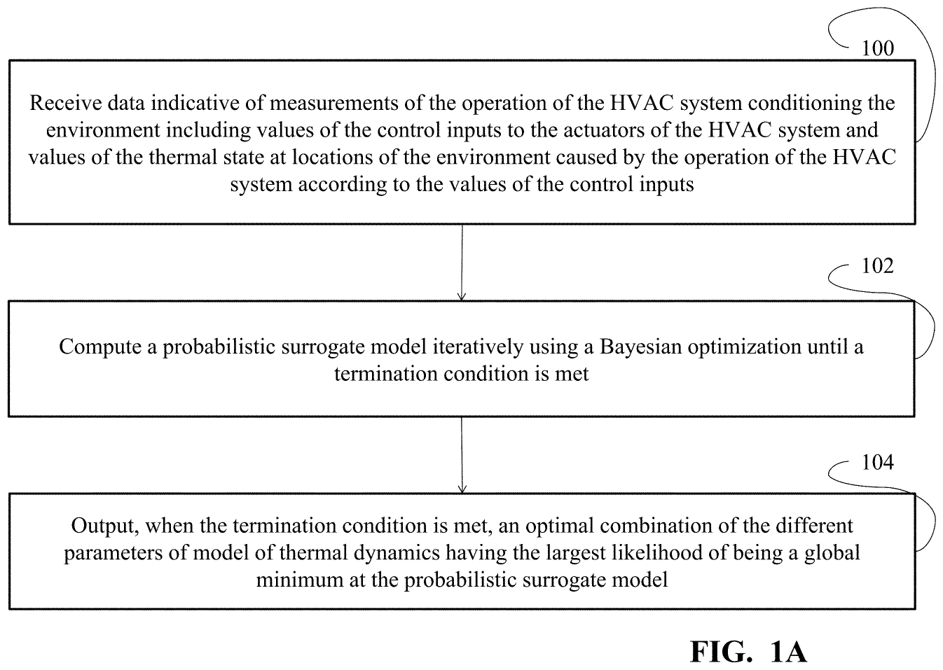

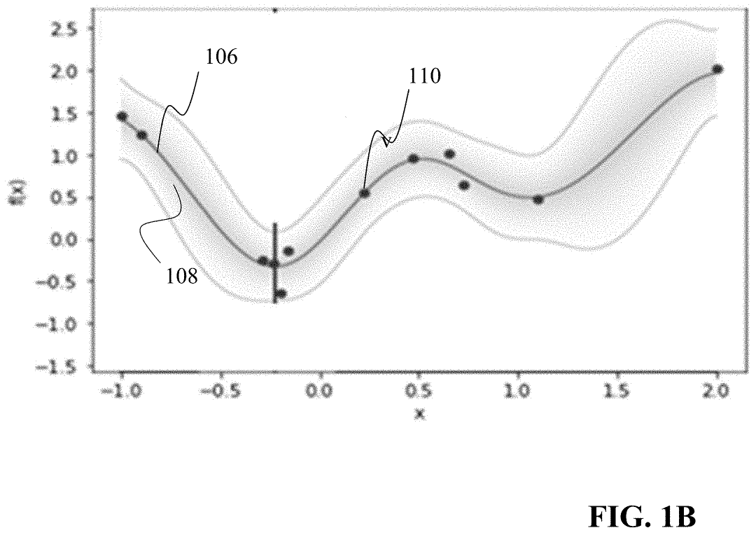

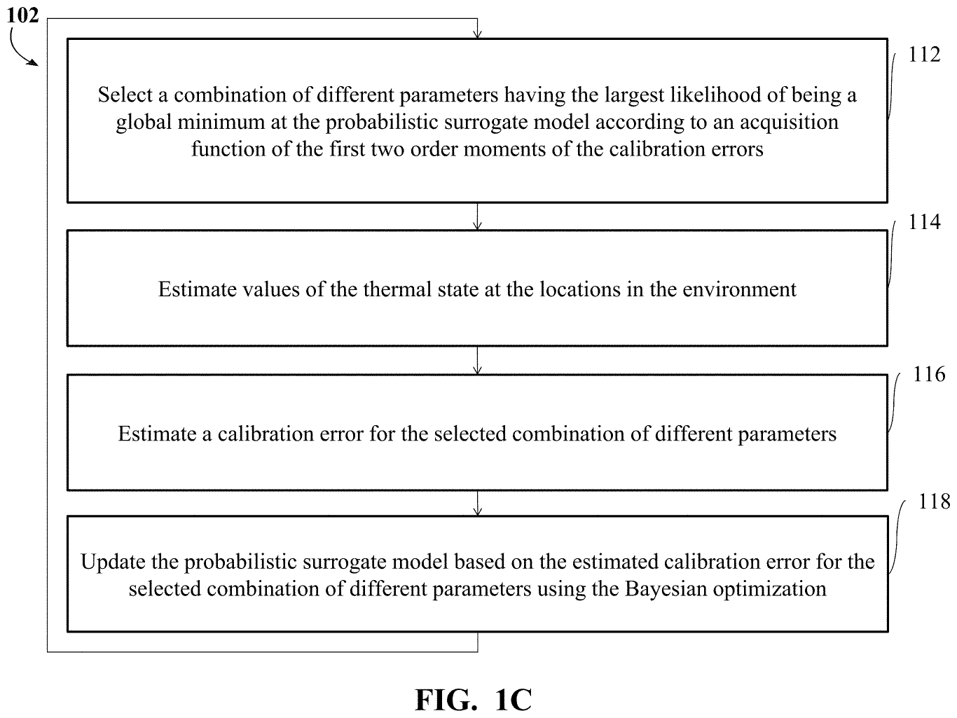

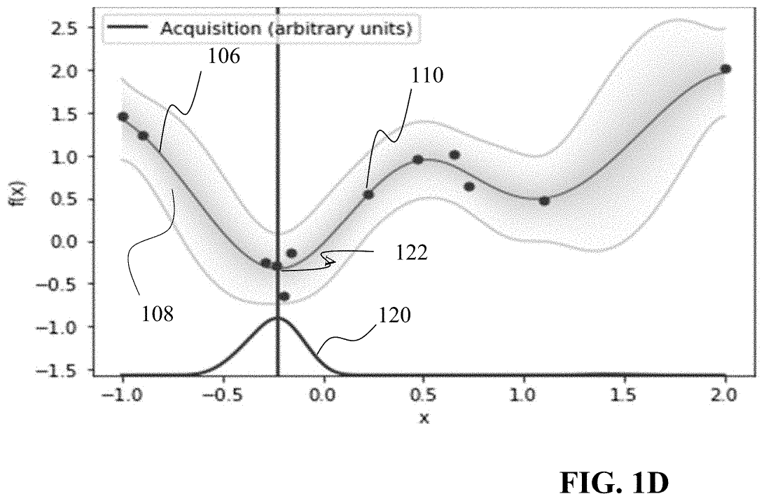

FIG. 1A shows a block diagram of principles used by some embodiments for calibrating a model of thermal dynamics of thermal state in an environment of a building. The building is installed with heating, ventilating and air conditioning (HVAC) system. The environment may be a room or space of the building, or the whole building where the HVAC system is installed. In some embodiments, the environment may correspond to space of the building where occupants are located or reside. In various implementations, the HVAC system may include multiple HVAC units installed in the environment. The HVAC system is configured to output air in the environment to condition the environment and ensure thermal comfort of the occupants of the environment. Thermal states of the outputted air include a temperature and a velocity of the air outputted by the HVAC system. In an alternate embodiment, the thermal state of the outputted air includes one or combination of the temperature, the velocity, and humidity of the air outputted by the HVAC system.

The HVAC system includes actuators such as an indoor fan, an outdoor fan, an expansion valve actuator, and the like. The actuators may be controlled according to corresponding control inputs, e.g., a speed of the indoor fan, a speed of the outdoor fan, a position of the expansion valve, a speed of a compressor, and the like. Additionally or alternatively, in some implementations, the control inputs may include a value of temperature and/or a value of humidity. In response to controlling the actuators of the HVAC system according to the corresponding control inputs, the thermal state in the environment changes.

According to an embodiment, the control inputs are determined based on different parameters of the model of thermal dynamics. The model of thermal dynamics is a digital twin model of dynamics of an operation of the HVAC system and thermal dynamics of the building, such that the model of thermal dynamics explains the change of the thermal state in the environment. The different parameters of the model of thermal dynamics define a physical structure of one or combination of the building, the actuators of the HVAC system, and an arrangement of the HVAC system to condition the environment. For instance, the different parameters of the model of thermal dynamics include parameters of the building such as a thickness of a floor of the building, an infrared emissivity of a roof of the building, a solar emissivity of the roof of the building, an airflow infiltration rate, interior room air heat transfer coefficient (HTC), exterior air HTC, and the like. Additionally, in some embodiments, the different parameters of the model of thermal dynamics include HVAC parameters such as an outdoor HEX heat transfer coefficient (HTC) adjustment factor, an indoor HEX HTC adjustment factor, an indoor HEX Lewis number, an outdoor HEX vapor HTC, an indoor HEX vapor HTC, an outdoor HEX liquid HTC, an indoor HEX liquid, an outdoor HEX 2-phase HTC, an indoor HEX 2-phase HTC, and the like.

However, the different parameters of the model of thermal dynamics are difficult to measure or to estimate from other physical quantities, in practice. For example, refrigerant-side heat transfer coefficients (HTCs) depend on an amount of oil circulating in pipes of the HVAC system, a configuration of tubes in a heat exchanger of the HVAC system, and other HVAC system and site-specific quantities, which are difficult to quantify. Additionally, uncertainties may exist in the dynamics of HVAC system operation, which makes the estimation of the different parameters of the model of thermal dynamics inaccurate. Also, the different parameters of the model of thermal dynamics are dynamic, i.e., the values of the different parameters vary over time. For example, a configuration of the building may be changed as a part of building maintenance or building repair work. The change in the configuration of the building affects the thermal dynamics of the building, which in turn leads to variation of the building parameters. Similarly, the HVAC parameters may change over time. Therefore, the different parameters of the model of thermal dynamics determined during a current time period may not be true at all times, or may be suboptimal for a different time period.

To mitigate such difficulties in estimation of the different parameters of the model of thermal dynamics, according to an embodiment, a calibration system for calibrating the model of thermal dynamics is provided. The calibration system may include a processor, and a memory configured to store instructions executable by the processor. The processor is configured to execute the instructions stored in the memory to perform steps required to calibrate the model of thermal dynamics. In an embodiment, the calibration system is configured to receive 100 data indicative of measurements of the operation of the HVAC system conditioning the environment including values of the control inputs to the actuators of the HVAC system and values of the thermal state at locations of the environment caused by the operation of the HVAC system according to the values of the control inputs.

Further, the calibration system computes 102 a probabilistic surrogate model iteratively, using a Bayesian optimization, until a termination condition is met. The probabilistic surrogate model provides a mapping between various combinations of different values of the different parameters of the model of thermal dynamics and their corresponding calibration errors. The probabilistic surrogate model defines at least the first two order moments of the calibration errors. In an embodiment, the at least first two order moments may include a mean of the calibration error and a variance of the calibration error (also referred to as confidence range). For example, for a given a combination of different values of the different parameters of the model of thermal dynamics, the probabilistic surrogate model provides not only a calibration error but also a confidence range around the calibration error.

FIG. 1B illustrates the mean and the confidence range provided by the probabilistic surrogate model, according to some embodiments. Dots 110 represent samples/observations. A curve 106 represents the mean and shaded area 108 represents the confidence range.

The calibration system iteratively computes the probabilistic surrogate model using the Bayesian optimization. FIG. 1C shows a block diagram of iterative computation of the probabilistic surrogate model using the Bayesian optimization, according to an embodiment. Some embodiments aim to select a combination of the different parameters (also referred as ‘data point’) that has to be queried next. As used herein, querying the combination of the different parameters refers to simulation of the thermal state in the environment based on the model of thermal dynamics with the combination of the different parameters and the received values of the control inputs corresponding to the received values of the thermal state. Some embodiments use an acquisition function of the first two order moments of the calibration error to select the combination of the different parameters to query next.

FIG. 1D shows a curve 120 of the acquisition function for selecting the combination of the different parameters that has to be queried next, according to some embodiments. The acquisition function uses the probabilistic mapping provided by the probabilistic surrogate model to select the combination of the different parameters to query next. In an embodiment, the acquisition function is maximized by the calibration system to select a combination of the different parameters having the largest likelihood of being a global minimum 122 at the probabilistic surrogate model, for querying. Therefore, the acquisition function is used as a guidance to select the combination of different parameters to query next.

To that end, the calibration system selects 112 the combination of different parameters having the largest likelihood of being a global minimum at the probabilistic surrogate model according to the acquisition function of the first two order moments of the calibration errors.

Further, the calibration system estimates 114 values of the thermal state at the locations in the environment by simulating the model of thermal dynamics with the selected combination of different parameters and the received values of the control inputs corresponding to the received values of the thermal state. The calibration system further estimates a calibration error 116 for the selected combination of different parameters. In an embodiment, the calibration system estimates the calibration error based on a difference between the received values of the thermal state at the locations in the environment and the values of the thermal state at the locations in the environment estimated according to the model of thermal dynamics with the selected combination of different parameters and the received values of the control inputs corresponding to the received values of the thermal state.

Furthermore, the calibration system updates 118 the probabilistic surrogate model based on the estimated calibration error for the selected combination of different parameters, using the Bayesian optimization. Further, in the next iteration, the calibration system selects a new combination of different parameters having the largest likelihood of being a global minimum at the updated probabilistic surrogate model, and estimates a calibration error for the new combination of different parameters. Subsequently, the calibration system again updates the updated probabilistic surrogate model based on the estimated calibration error for the new combination of different parameters, using the Bayesian optimization. Likewise, the probabilistic surrogate model is iteratively computed/updated until a termination condition is met. In an embodiment, the termination condition includes a number of iterations defined by a user.

Referring back to FIG. 1A, the calibration system monitors if the termination condition is met. When the termination condition is met, the calibration system outputs 104 an optimal combination of different parameters of the model of thermal dynamics having the largest likelihood of being a global minimum at the probabilistic surrogate model.

The optimal combination of different parameters of the model of thermal dynamics may be determined, as described above, offline (i.e., in advance). Additionally or alternatively, in some implementations, the optimal combination of different parameters of the model of thermal dynamics may be determined online, i.e., in real-time. For instance, the calibration system may be integrated with the HVAC system installed to condition the environment, and the calibration system may output the optimal combination of different parameters during the operation of the HVAC system.

Further, in some alternate embodiments, the optimal combination of different parameters of the model of thermal dynamics may be determined offline, and the model of thermal dynamics may be updated online. For instance, the optimal combination of different parameters of the model of thermal dynamics is determined offline and submitted to a controller of the HVAC system. The controller may determine control inputs to the actuator of the HVAC system based on the optimal combination of different parameters. However, when the physical structure of the building and/or the actuators of the HVAC system changes, the calibration system may update the model of thermal dynamics online by estimating a new optimal combination of different parameters in real time according to the change in the physical structure of the building and/or the actuators of the HVAC system. Further, the new optimal combination of different parameters may be submitted to the controller of the HVAC system. Consequently, the controller may determine control inputs to the actuator of the HVAC system based on the new optimal combination of different parameters.

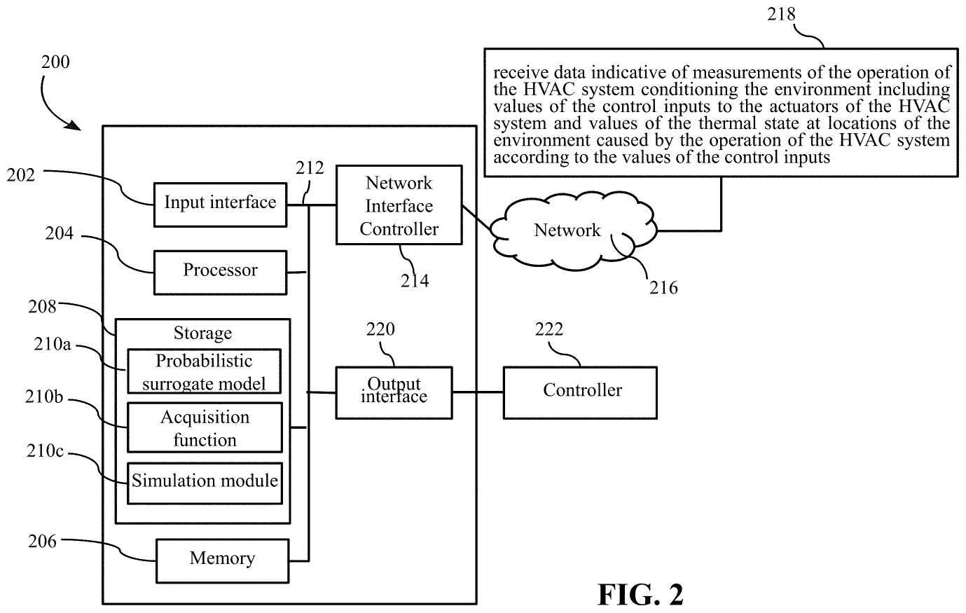

FIG. 2 shows a block diagram of the calibration system 200 for calibrating the model of thermal dynamics, according to some embodiments. The calibration system 200 can have a number of interfaces connecting the calibration system 200 with other systems and devices. For example, a network interface controller (NIC) 214 is adapted to connect the calibration system 200, through a bus 212, to a network 216. Through the network 216, either wirelessly or through wires, the calibration system 200 may receive the data indicative of measurements of the operation of the HVAC system conditioning the environment including values of the control inputs to the actuators of the HVAC system and the values of the thermal state at locations of the environment caused by the operation of the HVAC system according to the values of the control inputs. Additionally or alternatively, the data 218 indicative of the measurements of the operation of the HVAC system and the values of the thermal state at locations of the environment may be received via an input interface 202.

The calibration system 200 includes a processor 204 configured to execute stored instructions, as well as a memory 206 that stores instructions that are executable by the processor 204. The processor 204 can be a single core processor, a multi-core processor, a computing cluster, or any number of other configurations. The memory 206 can include random access memory (RAM), read only memory (ROM), flash memory, or any other suitable memory systems. The processor 204 is connected through the bus 212 to one or more input and output devices. Further, the calibration system 200 includes a storage device 208 adapted to store different modules storing executable instructions for the processor 204. The storage device 208 can be implemented using a hard drive, an optical drive, a thumb drive, an array of drives, or any combinations thereof.

The storage device 208 is configured to store a probabilistic surrogate model 210a providing a mapping between various combinations of different values of the different parameters of the model of thermal dynamics and their corresponding calibration errors. The storage device 208 is further configured to store an acquisition function 210b. The acquisition function 210b is used to select a combination of different parameters of the model of thermal dynamics to query/sample next. In some embodiments, the acquisition function 210b is used to select an optimal combination of different parameters of the model of thermal dynamics having the largest likelihood of being a global minimum at the probabilistic surrogate model. Further, the storage device 208 may store a simulation module 210c configured to simulate the model of thermal dynamics with the selected combination of different parameters and the received values of the control inputs corresponding to the received values of the thermal state, for estimating values of the thermal state at the locations in the environment.

In some embodiments, the processor 204 is configured to compute a probabilistic surrogate model providing a probabilistic mapping between various combinations of different values of the different parameters of model of thermal dynamics and their corresponding calibration errors. The probabilistic surrogate model is computed iteratively using the Bayesian optimization until the termination condition is met. The processor 204 is further configured to output, when the termination condition is met, an optimal combination of the different parameters of model of thermal dynamics having the largest likelihood of being a global minimum at the probabilistic surrogate model according to the acquisition function 210b of the first two order moments of the calibration errors.

Additionally, the calibration system 200 may include an output interface 220. In some embodiments, the calibration system 200 is further configured to submit, via the output interface 220, the optimal combination of the different parameters of model of thermal dynamics to a controller 222 of the HVAC system. The controller 222 is configured to generate control inputs to the actuators of the HVAC system based on the optimal combination of the different parameters of model of thermal dynamics.

Let y_{0:T}= [symbol] _{T}(θ) denote a general model of thermal dynamics, parameterized by θ∈Θ⊂ [symbol] ⁿ^{_{θ}}. Admissible set of parameters Θ is assumed to be known at calibration time; for instance, Θ may denote a set of upper and lower bounds on parameters, obtained from physics or practical experience. An output vector y_{0:T}∈ [symbol] ⁿ^{_{y}}^{×T} contains all measured outputs from the building obtained over a time period [0, T].

In an embodiment, [symbol] _{T} (θ) may be a black-box model, where simulating [symbol] _{T}(θ) forward with a fixed (and admissible) set of parameters θ yields a vector of outputs

y_{0:T}=[y₀ y₁ . . . y_{T-1} y_{T}]

with each output measurement yₜ∈ [symbol] ⁿ^{_{y}}.
For instance, consider a building energy model

yₜ=η(xₜ, θ)+δ(xₜ)+ϵ(xₜ)

where η denotes an energy prediction component, δ is a model discrepancy, and ϵ is an observation error. By recursively simulating the building energy model from t=0 to t=T, a representation that conforms to the model [symbol] _{T}(θ) can be obtained.

In an alternate embodiment, the model of thermal dynamics may be represented using a state-space description. For example,

\dot{x}_{b}=f_{b}(x_{b}, xₑ, u_{b}, w_{b}, θ_{b})

\dot{x}ₑ=fₑ(xₑ, x_{b}, uₑ, wₑ, θₑ)

y=h(x_{b}, xₑ, u_{b}, uₑ, v_{b}, vₑ)

can be used by defining θ:=[θ_{b}, θₑ] and integrating from [0, T] to yield a model of the form [symbol] _{T}(θ). Here x, u, w, and v denote states, inputs, process noise, and measurement noise, respectively, and subscripts b and e correspond to the building and the HVAC system, respectively.

For performing data-driven model calibration, measured output data y_{0:T}^{★} is required. It is an object of some embodiments to obtain the optimal parameters θ^{★} such that a modeling error y_{0:T}^{★}− [symbol] _{T}(θ*) is minimized. To this end, a calibration-cost function J and the following optimization problem is formulated to find the optimal parameters

$${θ}^{★} = arg {min}_{θ ∈ Θ} J ( {y}_{0 : T}^{★} , {M}_{T} ( θ ) ) . \qquad ( 1 )$$

According to some embodiments, the calibration-cost function J is given by

J:=log(Σₜ₌₀^{T}(yₜ^{★}−yₜ)^{T}W(yₜ^{★}−yₜ)),

where W is a n_{y}×n_{y} positive-definite matrix that is used to assign importance or scale output errors. Natural logarithm promotes good numerical conditioning of the calibration-cost function J by transforming large or very small costs to consistent numerical values. Alternatively, in some embodiments, the calibration-cost function includes normalized root mean square error (RMSE), normalized mean bias error (NIVIBE), mean squared error (MSE), coefficient of variation of the RMSE (CVRMSE).

The problem (1) is solved by extracting samples from the parameter space Θ, forward simulating the model [symbol] _{T}(θ) from [0, T] to obtain simulated outputs yₜ, and computing the cost J or the calibration error. Values and history of the calibration-cost function evaluations drive future sampling and eventually yield optimal solutions (asymptotically, the optimal solution). This avoids dependence on an underlying description of [symbol] _{T}(θ). A number of samples, required to obtain optimal solutions to (1) in high-dimensional parameter spaces, grows due to dimensionality. The Bayesian optimization reduces sampling complexity by directing posterior samples based on updating prior knowledge, enabling calibration of the model of thermal dynamics with a large number of parameters.

In an embodiment, the Bayesian optimization includes the probabilistic surrogate model using a Gaussian process for providing the probabilistic mapping, and the acquisition function that exploits the probabilistic mapping provided by the probabilistic surrogate model to direct the querying of a consequent combination of the different parameters of the model of thermal dynamics.

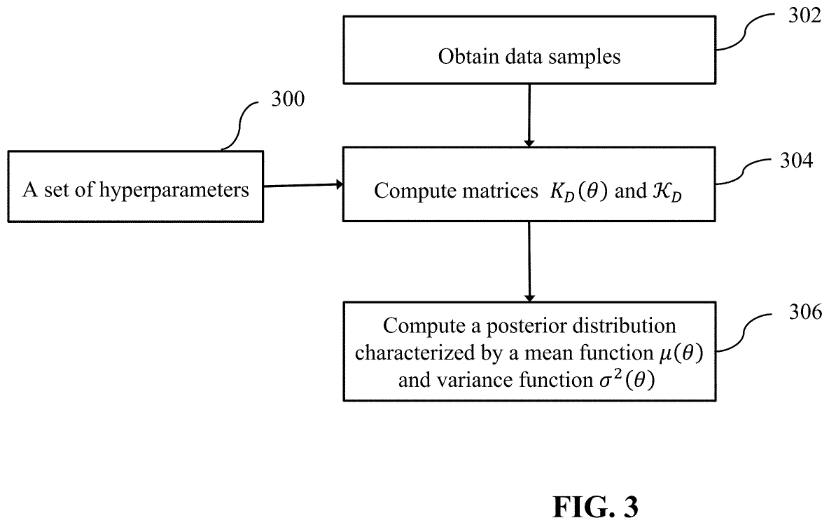

FIG. 3 shows a block diagram of the Gaussian process for determining the probabilistic surrogate model, according to some embodiments. According to an embodiment, the Gaussian processes are used to define a prior distribution over functions. It is assumed that the calibration cost/reward function J to be optimized is generated from such a prior distribution, characterized by a zero mean and a kernelized covariance function [symbol] (θ, θ′). The kernelized covariance function [symbol] is responsible for defining characteristics of the calibration-cost function J such as smoothness, robustness to additive noise, and the like. Some embodiments are based on the recognition that it is beneficial to use a Matern 3/2 function, as a Matern 3/2 function provides a good approximation of steady-state power functions without over smoothing.

At block 302, data samples are obtained. The user may randomly select a combination of the different parameters within admissible bounds of the parameter space. Further, a calibration error or the calibration-cost function J value is calculated for the randomly selected combination of the different parameters. The randomly selected combination of the different parameters and the corresponding calibration error form a data sample. For instance, five such data samples are obtained. Let N_{θ} denote an initial number of the data samples. The data samples are denoted by

{θₖ^{D}, J(θₖ^{D})+vₖ}_{{k=1}}^{N}^{_{θ}}

where v is additive white noise in a measurement channel with zero-mean and unknown covariance.

At block 304, given a set of hyperparameters 300 and σ₀ for a pre-decided kernel, matrices K_{D}(θ) and [symbol] _{D} are computed as

$${K}_{D} ( θ ) = [ \begin{matrix}𝒦 ( θ , {θ}_{1}^{D} ) & … & 𝒦 ( θ , {θ}_{N}^{D} )\end{matrix} ]$$

$$and$$

$${𝒦}_{D} = [ \begin{matrix}𝒦 ( {θ}_{1}^{D} , {θ}_{1}^{D} ) & … & 𝒦 ( {θ}_{1}^{D} , {θ}_{N}^{D} ) \\ ⋮ & ⋱ & ⋮ \\ 𝒦 ( {θ}_{N}^{D} , {θ}_{1}^{D} ) & … & 𝒦 ( {θ}_{N}^{D} , {θ}_{N}^{D} )\end{matrix} ] .$$

At block 306, based on the computed matrices K_{D}(θ) and [symbol] _{D}, a posterior distribution characterized by a mean function μ(θ) and variance function σ2(θ) is computed. The mean function μ(θ) and the variance function σ²(θ) are given by

μ(θ)=K_{D}(θ)^{T}( [symbol] _{D}+σₙ²I)⁻¹(J(θ)+v), (2)

σ²(θ)= [symbol] (θ, θ)−K_{D}(θ)^{T}( [symbol] _{D}+σₙ²I)⁻¹K_{D}(θ) (3)

According to an embodiment, the mean function μ(θ) and the variance function σ2(θ) define the surrogate model. It can be noted from equations (2) and (3) that the posterior distribution is dependent on selection of the kernel and the set of hyperparameters 300 such as l, σ₀ and σₙ.

In an embodiment, the set of hyperparameters 300 are determined by maximizing a log-marginal likelihood function

$$ℒ ( {σ}_{0} , {σ}_{n} , l ) = - \frac{1}{2} log \vert {𝒦}_{n} \vert - \frac{1}{2} {ξ}^{⊤} {𝒦}_{n} ξ + \frac{p}{2} log 2 π , \qquad ( 4 )$$

with [symbol] ₙ= [symbol] _{D}+σₙ²I and ξ=J(θ)+v. The problem given by equation (4) can be solved using quasi-Newton methods. In an alternate embodiment, the problem given by equation (4) can be solved using adaptive gradient methods.

Alternatively, in some embodiments, the probabilistic surrogate model can be determined by neural process regression or Bayesian neural networks.

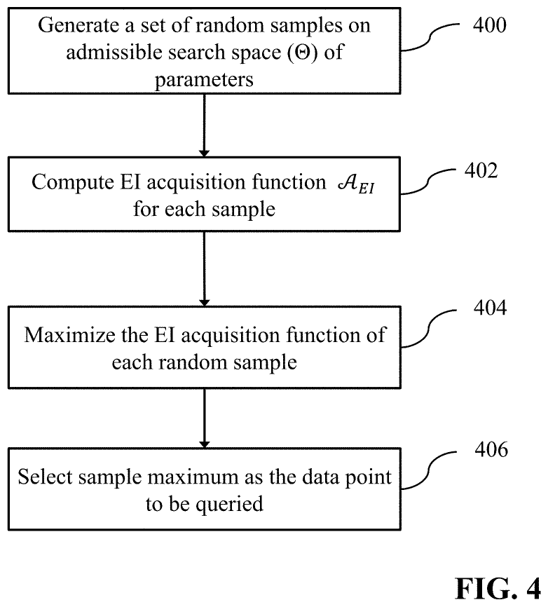

FIG. 4 shows a block diagram for selecting the data point (i.e., a combination of the different parameters) to query next, according to some embodiments. The acquisition function uses the probabilistic surrogate model to compute the data-point that has to be queried. The data-point that has to be queried is given by

θ_{N}_{_{θ}}⁺¹:=argmax [symbol] (θ). , . . . (5)

As the equation (5) depends on the Gaussian process approximated function and not on the actual function J, maximization of the acquisition function [symbol] involves computing rather than expensive function evaluations. In an embodiment, the acquisition function [symbol] is an expected improvement (EI) acquisition function. The EI acquisition function is given by

[symbol]

_{EI}(θ)=σ(θ)(γ(θ)Φ(γ(θ))+φ(γ(θ))) (6)

where ϕ is a density function of a zero-mean one-variance normal distribution, Φ is a cumulative distribution function, and

$$γ ( θ ) = \frac{{J}_{best} - μ ( θ )}{σ ( θ )}$$

where J_{best} is the lowest calibration error obtained so far with the data samples {θₖ}_{{k=1}}^{N}^{_{θ}}.

According to an embodiment, the maximization of the EI acquisition function (6) is carried out to compute the data point to be queried. At block 400, a set of random samples on admissible search space (Θ) of the different parameters of model of thermal dynamics are generated.

Further, at block 402, the EI acquisition function [symbol] _{EI} is computed for each sample.

At block 404, maximization of the EI acquisition function of each random sample is carried out. At block 406, sample maximum is selected as the data point to be queried.

To that end, the acquisition function (e.g., equation (6)) provides the data point to query. After querying at the selected data point, a corresponding calibration error is obtained. Some embodiments are based on the recognition that the data point determined from the acquisition function can be used to update/retrain the probabilistic surrogate model to increase accuracy of the probabilistic surrogate model. In particular, with the data samples and the data point selected using the acquisition function, the set of hyperparameters is re-computed.

Similarly, in the next iteration, with the updated/retrained probabilistic surrogate model, the acquisition function (e.g., equation (6)) can be used to select another data point to be queried. Further, the other data point selected can be used to again update/retrain the updated/retrained probabilistic surrogate model. Such iterations of updating the probabilistic surrogate model are carried out until the termination condition is met.

Alternatively, in some implementations, a probability of improvement acquisition function, or upper confidence bound acquisition function can be used to select the data point to query next.

Some embodiments are based on the recognition that inversion and determinant operations typically used in the Gaussian process (GP) result in cubic complexity with the number of data points, which implies that using the Gaussian process in moderate or high-dimensional parameter spaces is not practical, since finding optimal solutions in such spaces typically requires sampling and evaluating the calibration-cost function a large number of times. To render the Bayesian optimization (BO) tractable in high-dimensional parameter spaces, some embodiments provide a scalable BO framework employing sparse Gaussian processes. To that end, an SGP-based Bayesian Optimization (SGP-BO) is formulated. Alternatively, in some embodiments, a scalable BO framework may be based on neural process regression or Bayesian neural networks.

The sparse Gaussian processes (SGPs) techniques curtail expensive operations on N_{θ}×N_{θ} kernel matrices by constructing a low-rank approximation [symbol] _{D} of the exact matrix [symbol] _{D}. From its definition and with aid of Woodbury identity and additional lemmas, expressions describing the posterior mean and variances of SGPs can be computed efficiently by exploiting rank deficiency of the matrices, therein greatly reducing computational complexity during training.

Let θ′ₖ for k=1, . . . , N′_{θ} denote inducing points, also known as pseudo-inputs, for a given SGP technique. The inducing points are responsible for compressing the data samples information, and are usually chosen to be much smaller than an initial number of samples: N′_{θ}«N_{θ}. Further, let [symbol] _{Dm} be a tall matrix of kernel evaluations at inputs θₖ^{D} and the inducing points θ′ₖ, and [symbol] _{mD} be its transpose. Finally, [symbol] ₘₘ denotes a square kernel matrix analogous to [symbol] _{D}, but with evaluations at the inducing points. Hence, [symbol] ₘₘ is much smaller than [symbol] _{D}.

The computational complexity associated with the GPs resides in dealing with the N_{θ}×N_{θ} kernel matrix [symbol] _{D} . More specifically, determinant and inverse of the kernel matrix [symbol] _{D} needs to be computed during the training and prediction phases. To circumvent such a problem, SGP techniques use a low-rank surrogate matrix

[symbol]

_{d}= [symbol] _{Dm} [symbol] ₘₘ [symbol] _{mD} (7)

where [symbol] _{D}≈ [symbol] _{D}, along with Woodbury inversion lemma and Sylvester determinant theorem to greatly reduce overall complexity. As an outcome of this process, final SGP predictive mean and variance expressions only involve the inversion of [symbol] ₘₘ rather than [symbol] _{D}.

An example of a SGP technique that is built on (7) is a fully independent training conditional (FITC). The FITC technique can be statistically interpreted as a prior approximation, which is followed by an exact inference step. A central simplifying assumption made is a conditional independence

p(J_{θ}, J*|J′_{θ})=p(J_{θ}|J′_{θ})p(J*|J′_{θ}),

where J_{θ}, J′_{θ}, J*_{θ} are the calibration cost at the already queried data points, at the inducing points, and at an unknown arbitrary query point, respectively. Such equality establishes that the inducing points form a bottleneck through which the training information has to pass in order to influence new query data points. The final FITC predictive posterior distribution can be shown to be still Gaussian with the following mean and variances:

μ_{FITC}(θ)=\tilde{K}_{D}(θ)^{T}( [symbol] _{D}+Λ)⁻¹J(θ),

σ_{FITC}²(θ)= [symbol] (θ, θ)−\tilde{K}_{D}(θ)^{T}( [symbol] _{d}+Λ)⁻¹\tilde{K}_{D}(θ),

where [symbol] _{D}(θ)= [symbol] ₘ [symbol] ₘₘ⁻¹ [symbol] _{mD} and Λ=diag( [symbol] _{D}− [symbol] _{D}+σₙ²I). Term [symbol] _{D}− [symbol] _{D} can be regarded as a source of heteroscedastic noise, i.e., a measurement disturbance with input-dependent levels.

In contrast with FITC, variational free energy (VFE) method is a sparse technique that approximates exact GP posterior density. This confers to VFE inherent robustness against overfitting since the data is not considered directly. Further, VFE always improves its fitting performance with addition of new inducing points. A VFE model is defined as a simplified distribution that minimizes a distance to the exact GP posterior as measured by Kullback-Leibler (KL) divergence metric. Using tools from variational calculus, a closed-form solution for this problem can be found, resulting in another Gaussian process with the following predictive equations

ξ_{VFE}(θ)=\tilde{K}_{D}(θ)^{T}( [symbol] _{D}+σₙ²I)⁻¹J(θ),

σ_{VFE}²(θ)= [symbol] (θ, θ)−\tilde{K}_{d}(θ)^{T}( [symbol] _{D}+σₙ²I)⁻¹\tilde{K}_{D}(θ),

A training objective used in both of the aforementioned SGP frameworks, i.e., the FITC and VFE, can be expressed as

$$\tilde{ℒ} = - \frac{1}{2} log \vert \tilde{{𝒦}_{D}} + G \vert - \frac{1}{2} {J ( θ )}^{⊤} {( \tilde{{𝒦}_{D}} + G )}^{- 1} J ( θ ) - \frac{1}{2 {σ}_{n}^{2}} Tr ( T ) - \frac{p}{2} log 2 π ,$$

where for FITC, G=diag( [symbol] _{D}− [symbol] _{D}+σₙ²I) and T=0; whereas for VFE, G=σₙ²I and T= [symbol] _{d}− [symbol] _{D}; Tr(.) denotes a trace of a matrix. Maximizing [symbol] can be used not only to select the best kernel hyperparameters, but also to optimize the inducing point locations, hence completely specifying sparse approximations.

After a suitable number of iterations of the SGP-based Bayesian Optimization (SGP-BO), the SGP is expected to learn the underlying function J and the best solution obtained thus far is considered as the optimal set of the different parameters. The number of iterations of SGP-BO is defined by the user based on practical considerations such as a total amount of evaluations of J, that is, the total amount of simulations that can be run with a practical time budget.

### An Example of Using SGP-BO

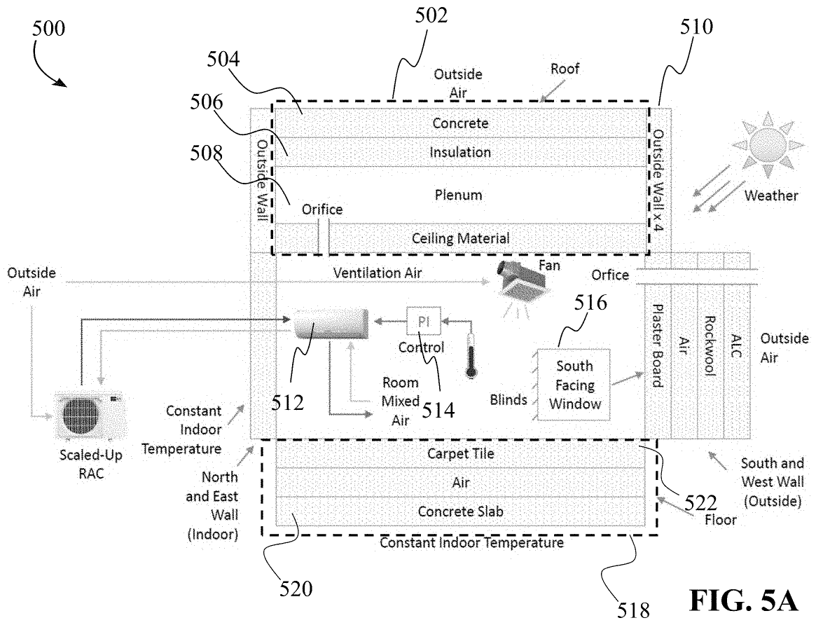

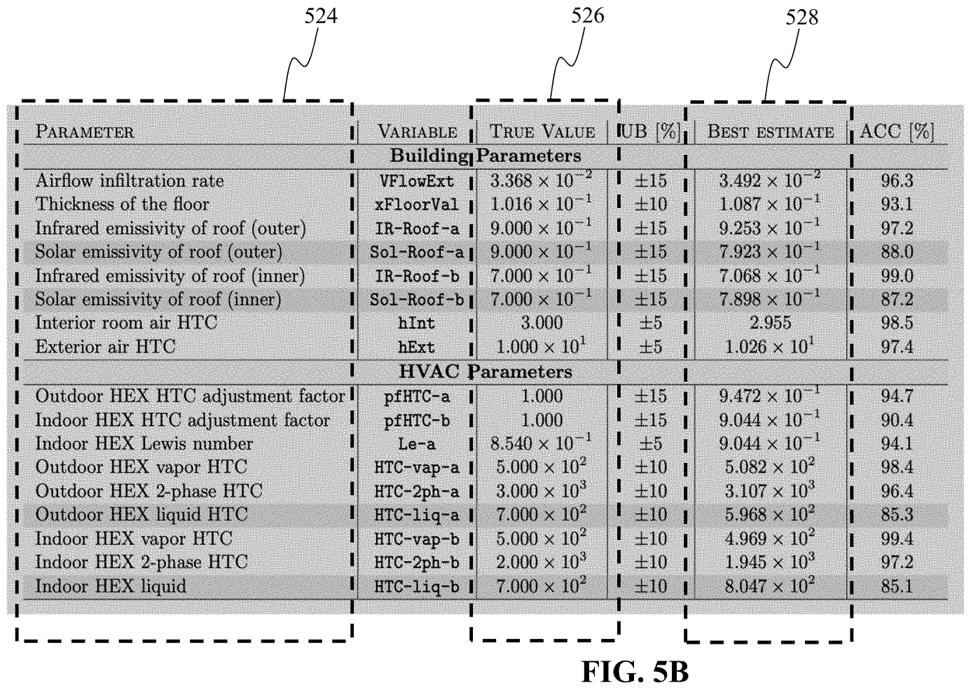

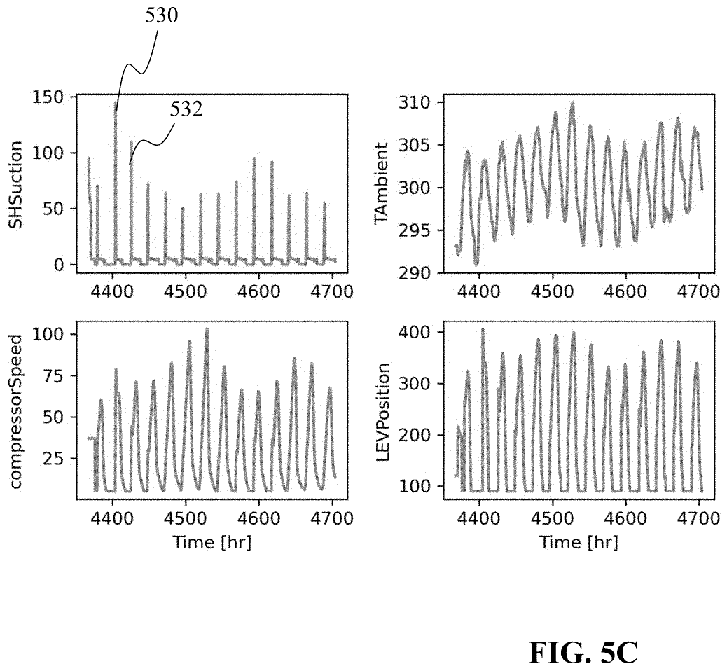

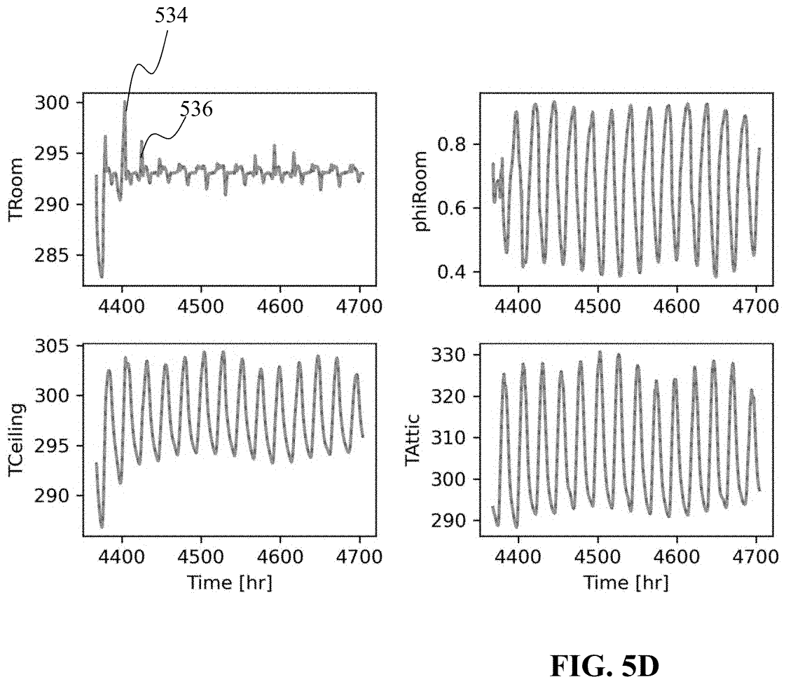

FIG. 5A shows some components of thermal dynamics of the building 500 and HVAC system 512 that are modeled in the model of thermal dynamics, according to some embodiments. The HVAC system 512 is installed in the building 500 to condition an environment of the building. A model of a vapor compression cycle of the HVAC system 512 comprising a compressor, a condensing heat exchanger, an electronic expansion valve, and an evaporating heat exchanger, is constructed. The vapor compression cycle behavior is dominated by the heat exchangers over time scales of interest. Therefore, the model of a vapor compression cycle uses dynamic models of the heat exchangers and algebraic (static) models of the compressor and the electronic expansion valve. For the sake of simplicity, a lumped parameter method was used to characterize dynamics of a refrigerant flow in the heat exchangers. In an embodiment, a Helmholtz equation-of-state based model may be used to describe the refrigerant properties, while an ideal gas mixture may be used for the moist air model.

A simple isenthalpic model of the electronic expansion valve and mass flow rate is regularized in a neighborhood of zero flow to prevent a derivative of the mass flow rate from tending toward infinity. A flow coefficient is determined via calibration against experimental data. An operation of the compressor may be described by relating a volumetric efficiency and an isentropic efficiency to a suction pressure, a discharge pressure, and a compressor frequency.

Further, building models are constructed from an open-source Modelica Buildings library. A room model is based on a physics-based behavior of fundamental materials and commonly used components, while a zone air model is a mixed air single-node model with one bulk air temperature that interacts with all of the radiative surfaces and thermal loads in the room. According to an embodiment, the building models may be parameterized by a thickness of a roof 502, a thickness of outside wall 510, and a thickness of floor 518. The thickness of the roof depends on a thickness of concrete layer 504, a thickness of insulation layer 506, and a size of plenum 508. The thickness of floor 518 depends on a thickness of concrete slab 520 and a thickness of the carpet tile 522.

In an embodiment, the building model consists of a one-story residence with nominal 2009 IECC-based construction. The one-story residence has a floor area, e.g., 112.24 m and is 2.6 m tall, and is oriented along with cardinal directions with a peak occupancy of 3 people. Each outside wall also has a window 516 of size, e.g., 1.52 m×2.72 m that admits solar heat gains into spaces of the building 500. A 10 cm thick concrete slab and 2 m of soil below the building 500 is also included to characterize interactions with thermal boundary conditions under the building 500, which was set to a constant 21° C. Additionally, a peaked attic is also included with a maximum height of 1.5 m, so that the building model includes two thermal zones.

Further, the building model is connected to the vapor compression cycle model, and a proportional integral (PI) controller 514 is implemented on a heat pump which used the compressor frequency to regulate a room temperature and the expansion valve position to regulate an evaporator superheat temperature. The PI controller 514 also implemented anti-windup to maintain stability while enforcing minimum and maximum actuator limits. The resulting joint building envelope/HVAC model (i.e., the model of thermal dynamics) is simulated using Atlanta-Hartsfield TMY3 file, and included convective and radiative heat loads of 2 W/m² and a latent load of 0.6 W/m² between hours of 8 AM and 6 PM, with weather-driven disturbances outside of these hours. Further, such a model is exported from Modelica using a Functional Mockup Interface, and resulting functional mockup unit (FMU) is imported into Python using the FMPy package to enable seamless integration of advanced machine learning modules.

Inputs and outputs of the model of thermal dynamics may be chosen to be similar to those which may be observed in a realistic experimental setting. Inputs of the heat pump include a room temperature set-point, an evaporator superheat set-point, and indoor and outdoor fan speeds. Inputs for the building model include convective, radiative, and latent heat loads as well as weather variables provided in TMY3 standard. Such heat loads may be estimated to reasonable accuracy via occupancy detection, load surveys, or other similar methods.

Further, ground-truth data is collected for calibration by simulating the Modelica model for a period of time(e.g., T=14 days) with the parameters of the model set to their true values. The 8 measured output sequences of the model are collected at 5 minute intervals. The SGP is initialized by choosing 100 randomly selected parameter samples from within the bounds Θ associated with each parameter. With each of the initial parameters samples, the Modelica model is simulated for the same time interval as the ground truth and obtain the estimated output sequence y_{0:T}. Subsequently, the calibration-cost function (1) is evaluated for each of the initial samples with the simulated and measured outputs. The initial collection of parameters and calibration-cost function values is used to construct an initial training set of the SGP. In an embodiment, Matern 3/2 kernels with dimension-wise separate length-scales may be used, since the admissible parameter space is not normalized.

The GP is constructed using a Python library gpflow, and uses 500 epochs of a limited-memory BFGS (L-BFGS) solver to obtain optimal hyperparameters for training Unlike MCMC methods that require tens of thousands of iterations to converge, the BO is set to run for, for example, 750 iterations, that is, the Modelica model is simulated 750 (BO iterations+100 (initial)=850 times from [0, T]. Further, the acquisition function is selected to be a lower-confidence-bound with [symbol] =1.96. For the acquisition function maximization, a uniform random sampling approach with 10,000 samples is adopted. Such sampling is cheap since it only requires evaluation of the SGP, rather than the simulation model. The specific SGP framework used is VFE with N′_{θ}=100 inducing points.

FIG. 5B shows a comparison table of the best estimates 528 of the parameters 524 after 750 iterations and true values 526 of the parameters 524, according to some embodiments. it can be observed that 13 of the 17 parameters (6/8 building and 7/9 equipment) are captured to above 90\% accuracy, despite using only one 2-week dataset and no additional pre-processing such as sensitivity analysis or data splitting. It is noteworthy that the 4 parameters with the lowest fits, highlighted in gray in the comparison table, are all >85\%.

FIG. 5C shows plots that illustrate how well the calibrated model has fit measured HVAC outputs, according to some embodiments. Dashed line 530 represents outputs generated by the Modelica model for the same set of inputs as the true system is affected by. Continuous line 532 represents the measured HVAC outputs. It can be observed that the dashed line 530 and the continuous line 532 overlap, which implies that the calibrated model accurately reproduces the HVAC outputs.

FIG. 5D shows plots that illustrate how well the calibrated model has fit measured building thermal outputs, according to some embodiments. Dashed line 534 represents outputs generated by the Modelica model for the same set of inputs as the true system is affected by. Continuous line 536 represents the measured building thermal outputs. It can be observed that the dashed line 534 and the continuous line 536 overlap, which implies that the calibrated model accurately reproduces the building thermal outputs.

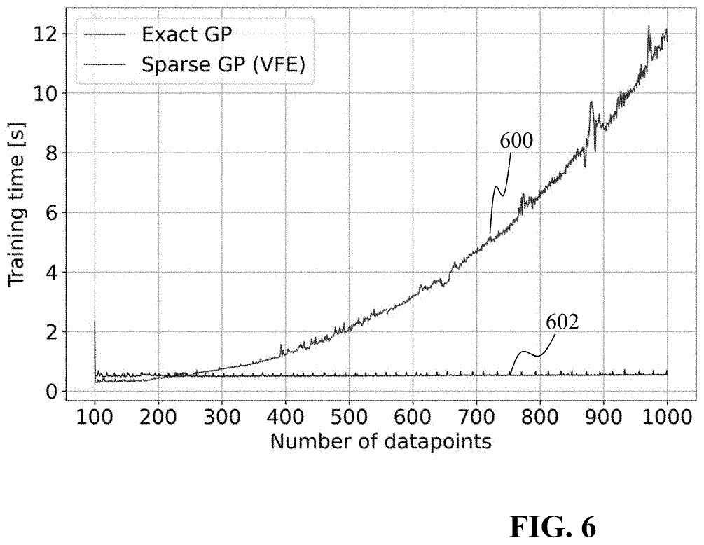

FIG. 6 shows a plot of training time v/s a number of datapoints for the exact GP and the sparse GP, according to some embodiments. A curve 600 indicates that the exact GP follows a cubic curve computationally, resulting in exorbitant training times. A curve 602 indicates that the sparse GP is linear with increasing data points, rendering the SGP-based Bayesian Optimization (SGP-BO) tractable for large-scale calibration problems.

The SGP-based Bayesian optimization yields decisive advantages, for example, is no burn-in period to acquire a practical distribution and no initial parameter guesses are required. However, due sequential nature of Bayesian optimization calibration performance is dictated by a quality of an initial SGP model. Therefore, the SGP-based Bayesian optimization is tested for robustness to initial conditions in which the calibration mechanism was run 50 times, with different initial random seeds (that is, different samples were extracted for the initial GP construction).

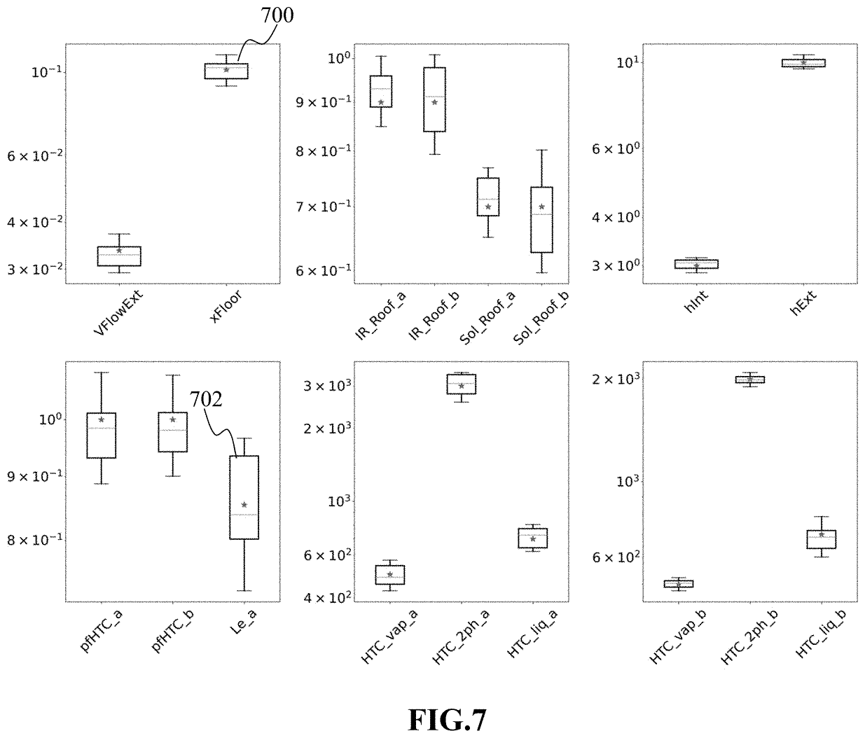

FIG. 7 shows box plots depicting performance of calibrating the model of thermal dynamics and the robustness of calibrating using the SGP-based Bayesian optimization, according to some embodiments. A median (horizontal orange line), quartiles (horizontal box lines), and range (whisker ends) for the best parameter set obtained over 50 runs are shown using boxplots, with the true value of parameter v shown with a ‘★’. It can be inferred from the box plots that the best parameter estimates are close to their true values, with (predictably) the worst calibration performance exhibited by the inner roof parameters. Also, the liquid heat transfer coefficients do not exhibit a significant decline over runs, but the Lewis number does. It is likely that this variation can be attributed to a time varying moisture removal rate of the evaporating heat exchanger and dependence of indoor relative humidity on both ambient conditions and internal latent loads.

Further, it can be observed that different parameters of the model of thermal dynamics have different rates of convergence. For example, box 700 for parameter xFloor is narrow, which indicates confidence of its mean value. Conversely, the box 702 for parameter indoor HEX Lewis number ‘Le-a’ is wide, which indicates a lack of confidence for convergence of this parameter. Such lack of confidence for the parameter indoor HEX Lewis number can be due to its insufficient excitation by current control inputs. To address this issue, some embodiments, fix the value of parameters with high confidence and change the control inputs to better excite the parameters with lower confidence.

In an embodiment, a threshold convergence confidence is set for each parameter. The processor 204 compares the confidence of convergence of each parameter with the corresponding threshold convergence confidence. The parameters, whose confidence of convergence is greater than the corresponding threshold convergence confidences, are fixed. The parameters whose confidence of convergence is less than the corresponding threshold convergence confidences are considered to be the parameters with lower convergence confidence. The processor 204 transmits data indicative of the parameters with the lower convergence confidence to the controller 222. The controller 222 determines, based on the received data, control inputs to at least one actuator of the HVAC system to better excite the parameters with lower confidence and increase convergence of the parameters with the lower convergence confidence.

Some embodiments are based on the recognition that installing the calibration system 200 on-site, i.e., that integrating the calibration system 200 with the HVAC system arranged to condition the environment, may limit the capability of the calibration system 200 only to that HVAC system. Some embodiments are based on the recognition that it is beneficial to configure the calibration system 200 to provide a cloud service, such that the calibration system 200 can estimate an optimal combination of the different parameters of the model of thermal dynamics of different HVAC systems. In other words, the cloud service capability of the calibration system may allow virtually integration of the calibration system 200 with multiple HVAC systems located at different locations. The cloud service refers to a wide range of services delivered on demand to user equipment, such as the HVAC system, over a network. The cloud services are designed to provide easy, affordable access to applications and resources, without a need for internal infrastructure or hardware at a location of the user equipment.

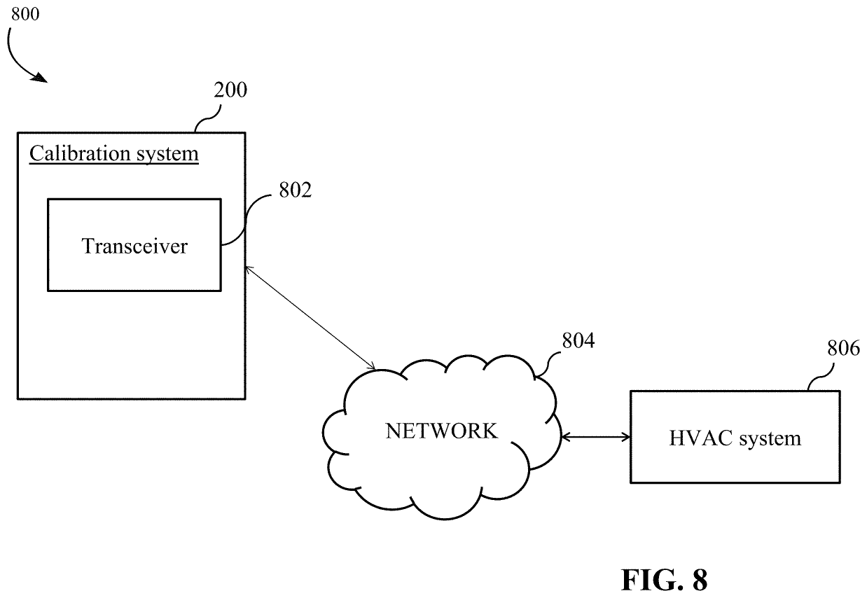

FIG. 8 shows a working environment 800 of the calibration system 200 providing the cloud service to HVAC system 806, according to some embodiments. The calibration system 200 and the HVAC system 806 are coupled directly or indirectly to a network 804. Components described in the working environment 800 may be further broken down into more than one component and/or combined in any suitable arrangement. Further, one or more components may be rearranged, changed, added, and/or removed.

The calibration system 200 includes a transceiver 802 configured to exchange information over the network 804 For example, the transceiver 802 may receive a model of thermal dynamics and data indicative of measurements of the operation of the HVAC system 806, via the network. The network 804 may be a wireless communication network, such as cellular, Wi-Fi, internet, local area networks, or the like. The calibration system 200 computes an optimal combination of the different parameters for the received model of thermal dynamics, using the SGP-based Bayesian optimization.

Further, the transceiver 802 transmits the computed optimal combination of the different parameters to the HVAC system 806, via the network 804. Additionally, in some embodiments, the HVAC system 806 may include a controller (e.g., the controller 222). The controller may determine control inputs to actuators of the HVAC system 806, based on the optimal combination of the different parameters received from the calibration system 200. The control inputs control the states of the actuators of the HVAC system 806 to condition the environment as desired.

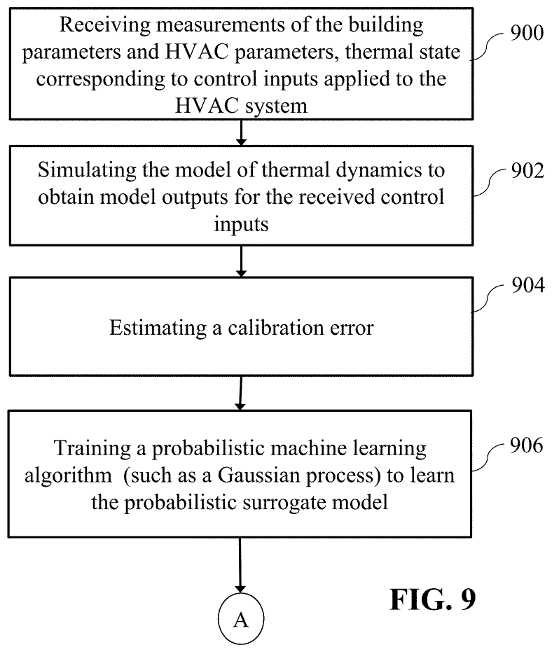

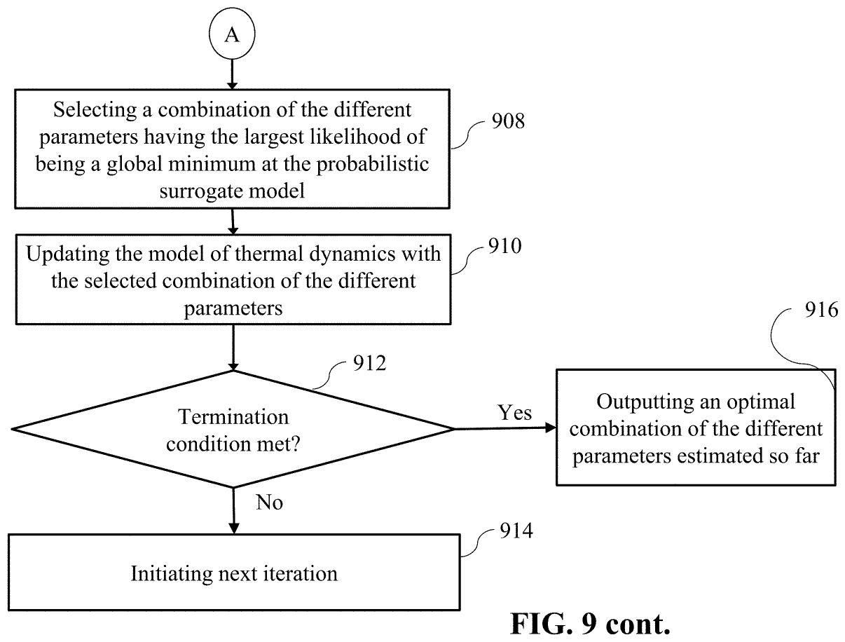

FIG. 9 shows a flowchart of a calibration method for calibrating the model of thermal dynamics, according to some embodiments. At block 900, the calibration method includes receiving measurements of the building parameters and HVAC parameters, a thermal state corresponding to control inputs applied to the HVAC system. At block 902, the calibration method further includes simulating the model of thermal dynamics to obtain model output (e.g., thermal state) for the received control inputs. At block 904, the calibration method further includes estimating a calibration error as a difference between the received thermal state and the model output.

At block 906, the calibration method further includes training a probabilistic machine learning algorithm (such as the Gaussian process) to learn the probabilistic surrogate model. The probabilistic surrogate model defines at least the first two order moments of the calibration error. At block 908, the calibration method further includes selecting a combination of the different parameters having the largest likelihood of being a global minimum at the probabilistic surrogate model according to the acquisition function of the first two order moments of the calibration error. At block 910, the calibration method further includes updating the model of thermal dynamics with the selected combination of the different parameters. At block 912, the calibration method further includes checking if the termination is met. If the termination condition is not met, then, at block 914, the calibration method further includes initiating the next iteration. If the termination condition is met, then, at block 916, the calibration method further includes outputting an optimal combination of the different parameters estimated so far.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

1. A calibration system for calibrating a model of thermal dynamics of thermal state in an environment of a building conditioned by an operation of a heating, ventilating, and air-conditioning (HVAC) system, wherein the model of thermal dynamics is a digital twin model of dynamics of the operation of the HVAC system and thermal dynamics of the building, such that the model of thermal dynamics explains a change of the thermal state in the environment in response to controlling actuators of the HVAC system according to corresponding control inputs based on different parameters of the model of thermal dynamics defining a physical structure of one or combination of the building, the actuators of the HVAC system, and an arrangement of the HVAC system in the building to condition the environment, the calibration system comprising: at least one processor; and memory having instructions stored thereon that, when executed by the at least one processor, cause the calibration system to:
receive data indicative of measurements of the operation of the HVAC system conditioning the environment including values of the control inputs to the actuators of the HVAC system and values of the thermal state at locations of the environment caused by the operation of the HVAC system according to the values of the control inputs;
compute a probabilistic surrogate model providing a probabilistic mapping between various combinations of different values of the different parameters of model of thermal dynamics and their corresponding calibration errors, wherein the probabilistic surrogate model defines at least the first two order moments of the calibration errors, and wherein the probabilistic surrogate model is computed iteratively using a Bayesian optimization until a termination condition is met; and
calibrate, when the termination condition is met, the model of thermal dynamics with an optimal combination of the different parameters having the largest likelihood of being a global minimum at the probabilistic surrogate model according to an acquisition function of the first two order moments of the calibration errors.

2. The calibration system of claim 1, wherein to perform an iteration for computing the probabilistic surrogate model iteratively using the Bayesian optimization, the processor is configured to:
select a combination of different parameters having the largest likelihood of being a global minimum at the probabilistic surrogate model according to an acquisition function of the first two order moments of the calibration errors;
estimate a calibration error for the selected combination of different parameters based on a difference between the received values of the thermal state at the locations in the environment and simulated values of the thermal state at the locations in the environment estimated according to the model of thermal dynamics with the selected combination of different parameters and the received values of the control inputs corresponding to the received values of the thermal state; and
update the probabilistic surrogate model based on the estimated calibration error for the selected combination of different parameters using the Bayesian optimization.

3. The calibration system of claim 1, wherein the different parameters include one or a combination of parameters of the building and HVAC parameters, wherein the parameters of the building include a thickness of floor of the building, an infrared emissivity of a roof of the building, a solar emissivity of the roof of the building, an airflow infiltration rate, interior room air heat transfer coefficient (HTC), and exterior air HTC, and wherein HVAC parameters include an outdoor HEX heat transfer coefficient (HTC) adjustment factor, an indoor HEX HTC adjustment factor, an indoor HEX Lewis number, an outdoor HEX vapor HTC, an indoor HEX vapor HTC, an outdoor HEX liquid HTC, an indoor HEX liquid, an outdoor HEX 2-phase HTC, and an indoor HEX 2-phase HTC.

4. The calibration system of claim 1, wherein the Bayesian optimization includes a cost/reward function model using a Gaussian process for computing the probabilistic surrogate model providing the probabilistic mapping.

5. The calibration system of claim 1, wherein the Bayesian optimization includes the acquisition function that exploits the probabilistic mapping provided by the probabilistic surrogate model to direct querying of consequent combination of the different parameters.

6. The calibration system of claim 5, wherein the acquisition function includes an expected improvement (EI) acquisition function.

7. The calibration system of claim 6, wherein to select the combination of parameters having the largest likelihood of being the global minimum of the probabilsitc surrogate model, the processor is further configured to:
generate a set of random samples on an admissible search space of the different parameters of the model of thermal dynamics;
compute the EI acquisition function for each random sample; and
maximize the EI acquisition function of each random sample.

8. The calibration system of claim 1, wherein the Bayesian optimization comprises one or a combination of a sparse Gaussian process, a neural process, and a Bayesian neural network.

9. The calibration system of claim 1, wherein the processor is operatively connected to the HVAC system including a controller determining the control inputs to the actuators of the HVAC system using the optimal combination of the different parameters of the model of thermal dynamics.

10. The calibration system of claim 9, wherein the processor is further configured to determine one or more parameters of the model of thermal dynamics having lower convergence confidence, based on a comparison of a convergence confidence of each parameter with a corresponding confidence threshold, and transmit data indicative of the one or more parameters of the model of thermal dynamics having lower convergence confidence to the controller.

11. The calibration system of claim 10, wherein the controller is configured to update a control input to at least one actruator of the HVAC system, based on the data indicative of the one or more parameters of the model of thermal dynamics having lower convergence confidence, to update the data indicative of measurements of the operation of the HVAC system increasing convergence of the one or more parameters.

12. The calibration system of claim 1, wherein the calibration system provides a cloud service and includes a transceiver for exchanging information over a network to receive the model of thermal dynamics and data indicative of measurements of the operation of the HVAC system, and transmit the optimal combination of the different parameters of the received model.

13. A calibration method for calibrating a model of thermal dynamics of thermal state in an environment of a building conditioned by an operation of a heating, ventilating, and air-conditioning (HVAC) system, wherein the model of thermal dynamics is a digital twin model of dynamics of the operation of the HVAC system and thermal dynamics of the building, such that the model of thermal dynamics explains a change of the thermal state in the environment in response to controlling actuators of the HVAC system according to corresponding control inputs based on different parameters of the model of thermal dynamics defining a physical structure of one or combination of the building, the actuators of the HVAC system, and an arrangement of the HVAC system to condition the environment, the calibration method comprising:
receiving data indicative of measurements of the operation of the HVAC system conditioning the environment including values of the control inputs to the actuators of the HVAC system and values of the thermal state at locations of the environment caused by the operation of the HVAC system according to the values of the control inputs;
computing a probabilistic surrogate model providing a probabilistic mapping between various combinations of different values of the different parameters of model of thermal dynamics and their corresponding calibration errors, wherein the probabilistic surrogate model defines at least the first two order moments of the calibration errors, and wherein the probabilistic surrogate model is computed iteratively using a Bayesian optimization until a termination condition is met; and
outputting, when the termination condition is met, an optimal combination of the different parameters of the model of thermal dynamics having the largest likelihood of being a global minimum at the probabilistic surrogate model according to an acquisition function of the first two order moments of the calibration errors.

14. The calibration method of claim 13, wherein to perform an iteration for computing the probabilistic surrogate model iteratively using the Bayesian optimization, the method further comprises:
selecting a combination of different parameters having the largest likelihood of being a global minimum at the probabilistic surrogate model according to an acquisition function of the first two order moments of the calibration errors;
estimating a calibration error for the selected combination of different parameters based on a difference between the received values of the thermal state at the locations in the environment and simulated values of the thermal state at the locations in the environment estimated according to the model of thermal dynamics with the selected combination of different parameters and the received values of the control inputs corresponding to the received values of the thermal state; and
updating the probabilistic surrogate model based on the estimated calibration error for the selected combination of different parameters using the Bayesian optimization.

15. The calibration method of claim 13, wherein the different parameters include one or a combination of parameters of the building and HVAC parameters, wherein the parameters of the building include a thickness of floor of the building, an infrared emissivity of a roof of the building, a solar emissivity of the roof of the building, an airflow infiltration rate, interior room air heat transfer coefficient (HTC), and exterior air HTC, and wherein HVAC parameters include an outdoor HEX heat transfer coefficient (HTC) adjustment factor, an indoor HEX HTC adjustment factor, an indoor HEX Lewis number, an outdoor HEX vapor HTC, an indoor HEX vapor HTC, an outdoor HEX liquid HTC, an indoor HEX liquid, an outdoor HEX 2-phase HTC, and an indoor HEX 2-phase HTC.

16. The calibration method of claim 13, wherein the Bayesian optimization comprises a probabilistic surrogate model using a Gaussian process for providing the probabilistic mapping.

17. The calibration method of claim 13, wherein the Bayesian optimization includes an acquisition function that exploits the probabilistic mapping provided by the probabilistic surrogate model to direct querying of consequent combination of the different parameters.

18. The calibration method of claim 17, wherein the acquisition function includes an expected improvement (EI) acquisition function.

19. The calibration method of claim 13, wherein the Bayesian optimization comprises a sparse Gaussian process.

20. A non-transitory computer-readable storage medium embodied thereon a program executable by a processor for performing a method for calibrating a model of thermal dynamics of thermal state in an environment of a building conditioned by an operation of a heating, ventilating, and air-conditioning (HVAC) system, wherein the model of thermal dynamics is a digital twin model of dynamics of the operation of the HVAC system and thermal dynamics of the building, such that the model of thermal dynamics explains a change of the thermal state in the environment in response to controlling actuators of the HVAC system according to corresponding control inputs based on different parameters of the model of thermal dynamics defining a physical structure of one or combination of the building, the actuators of the HVAC system, and an arrangement of the HVAC system to condition the environment, the method comprising:
receiving data indicative of measurements of the operation of the HVAC system conditioning the environment including values of the control inputs to the actuators of the HVAC system and values of the thermal state at locations of the environment caused by the operation of the HVAC system according to the values of the control inputs;
computing a probabilistic surrogate model providing a probabilistic mapping between various combinations of different values of the different parameters of model of thermal dynamics and their corresponding calibration errors, wherein the probabilistic surrogate model defines at least the first two order moments of the calibration errors, and wherein the probabilistic surrogate model is computed iteratively using a Bayesian optimization until a termination condition is met; and
outputting, when the termination condition is met, an optimal combination of the different parameters of the model of thermal dynamics having the largest likelihood of being a global minimum at the probabilistic surrogate model according to an acquisition function of the first two order moments of the calibration errors.
